(19) United States
(12) Patent Application Publication
(10) Pub. No.: US 2012/0307941 A1
(43) Pub. Date: Dec. 6, 2012

(54) RADIO RECEIVER, METHOD OF CALIBRATING RADIO RECEIVER, METHOD OF CORRECTING TIME-INDUCED DEVIATION IN RADIO RECEIVER, AND RADIO BASE STATION APPARATUS

(75) Inventor: Shin WATANABE, Yokohama (JP)

(73) Assignee: FUJITSU LIMITED, Kawasaki-shi (JP)

(21) Appl. No.: 13/416,012

(22) Filed: Mar. 9, 2012

(30) Foreign Application Priority Data
May 30, 2011 (JP) 2011-120914

(51) Int. Cl. H04L 27/06

(52) U.S. Cl. 375/320

(57) ABSTRACT

A radio receiver includes a signal divider that divides an intermediate frequency signal obtained by converting a frequency of a radio frequency signal received at an analog reception circuit, into a plurality of signal fragments based on an amplitude, and outputs the signal segments; and a plurality of analog to digital converters that perform an analog to digital conversion on the respective signal fragments divided by the signal divider, and output the signal fragments toward a digital reception circuit.

### CROSS-REFERENCE TO RELATED APPLICATION

This application is based upon and claims the benefit of priority of the prior Japanese Patent Application No. 2011-120914, filed on May 30, 2011, the entire contents of which are incorporated herein by reference.

### FIELD

The embodiment and variations thereto discussed herein are related to a radio receiver, a method of calibrating a radio receiver, a method of correcting a time-induced deviation in a radio receiver, and a radio base station apparatus.

### BACKGROUND

The recent upsurge in demands for data communications in wireless communication systems, e.g., mobile telephone systems, has created greater needs for smaller base station apparatuses so that the traffic is distributed across the wireless communication systems.

At the same time, the frequencies employed for wireless communications in the wireless communication systems are becoming denser, with increasing communication speeds and prevalence of the broadband networks. As a result, wireless signals in different frequencies but in a very narrow range are present in communication service areas.

### SUMMARY

A first aspect of an embodiment is a radio receiver including: a signal divider that divides an intermediate frequency signal obtained by converting a frequency of a radio frequency signal received at an analog reception circuit, into a plurality of signal fragments based on an amplitude, and outputs the signal segments; and a plurality of analog to digital converters that perform an analog to digital conversion on the respective signal fragments divided by the signal divider, and output the signal fragments toward a digital reception circuit.

A second aspect of an embodiment is a method of calibrating a radio receiver including a signal divider that divides an intermediate frequency signal obtained by converting a frequency of a radio frequency signal received at an analog reception circuit, into a plurality of signal fragments based on an amplitude, and outputs the signal segments; and a plurality of analog to digital converters that perform an analog to digital conversion on the respective signal fragments divided by the signal divider, and output the signal fragments toward a digital reception circuit, the method including: inputting a calibration signal from an input side of the signal divider; comparing the calibration signal against a reference signal, and adjusting the calibration signal such that the calibration signal matches the reference signal; and determining a signal level of a pilot signal having a frequency different from a frequency of the intermediate frequency signal such that the pilot signal matches the adjusted calibration signal.

A third aspect of an embodiment is a method of correcting a time-induced deviation in a radio receiver including a signal divider that divides an intermediate frequency signal obtained by converting a frequency of a radio frequency signal received at an analog reception circuit, into a plurality of signal fragments based on an amplitude, and outputs the signal segments; and a plurality of analog to digital converters that perform an analog to digital conversion on the respective signal fragments divided by the signal divider, and output the signal fragments toward a digital reception circuit, the method including: inputting a calibration signal from an input side of the signal divider; comparing the calibration signal against a reference signal, and adjusting the calibration signal such that the calibration signal matches the reference signal; determining a signal level of a pilot signal having a frequency different from a frequency of the intermediate frequency signal such that the pilot signal matches the adjusted calibration signal; storing the signal level of the pilot signal as reference value information; and comparing an input pilot signal against the reference value information, and correcting the time-induced deviation in the signal division boundary in a signal divider.

A fourth aspect of an embodiment is a radio base station apparatus including a radio receiver including: a signal divider that divides an intermediate frequency signal obtained by converting a frequency of a radio frequency signal received at an analog reception circuit, into a plurality of signal fragments based on an amplitude, and outputs the signal segments; and a plurality of analog to digital converters that perform an analog to digital conversion on the respective signal fragments divided by the signal divider, and output the signal fragments toward a digital reception circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a typical radio receiver;

FIG. 2 is a diagram illustrating an example of the configuration of an analog reception unit depicted in FIG. 1;

FIG. 3 is a diagram illustrating an example of a spectrum of an IF signal;

FIG. 4 is a diagram illustrating an example of a waveform versus time plot of the IF signal;

FIG. 5 is a diagram illustrating an example of the configuration of a radio receiver in accordance with an embodiment;

FIG. 6 is a diagram illustrating an example of the configuration of an analog reception unit depicted in FIG. 5;

FIG. 7 is a diagram illustrating a waveform versus time plot of the signals after being combined in a digital reception unit;

FIG. 8 is a diagram illustrating an example of the configuration of a signal division circuit depicted in FIG. 5;

FIGS. 9A and 9B are diagrams illustrating an example of waveform versus time plots of signals output from the signal division circuit depicted in FIG. 6;

FIG. 10 is a diagram illustrating a waveform versus time plot of a signal combined in the digital reception unit when the signal division circuit depicted in FIG. 6 is used;

FIG. 11 is a diagram illustrating a waveform versus time plot of an error signal caused by a waveform distortion resulted from usage of the signal division circuit depicted in FIG. 6;

FIGS. 12A-12C are diagrams illustrating a method to correct a waveform distortion in accordance with an embodiment;

FIG. 13 is a diagram illustrating an example of the configuration of a level variable circuit depicted in FIG. 5;

FIG. 14 is a diagram illustrating a flow for a calibration in accordance with an embodiment;

FIG. 15 is a diagram illustrating a flow to correct a time-induced deviation in a radio receiver in accordance with an embodiment;

FIG. 16 is a diagram illustrating a spectrum of a calibration signal at the input and output ends of the AD converter depicted in FIG. 5;

FIG. 17 is a diagram illustrating a waveform versus time plot of calibration and reference signals in the digital reception unit depicted in FIG. 5;

FIG. 18 is a diagram illustrating spectra of pilot and calibration signals in the digital reception unit depicted in FIG. 5;

FIG. 19 is a diagram illustrating spectra of a desired signal at the input ends of the AD converters and respective signals observed in the digital reception unit during operation of the radio receiver depicted in FIG. 5;

FIG. 20 is a diagram illustrating a waveform versus time plot of a pilot signal observed in the digital reception unit during operation of the radio receiver depicted in FIG. 5;

FIG. 21 is a diagram illustrating an example of the configuration of a radio receiver in accordance with a first variation;

FIGS. 22A and 22B are diagrams illustrating waveform versus time plots of digital signals output from the AD converter depicted in FIG. 21;

FIG. 23 is a diagram illustrating an example of the configuration of a radio receiver in accordance with a second variation;

FIG. 24 is a diagram illustrating an example of the configuration of a radio receiver in accordance with a third variation; and

FIG. 25 is a diagram illustrating an example of the configuration of a radio base station apparatus.

### DESCRIPTION OF EMBODIMENT(S)

In the situation discussed above, a radio receiver may receive, not only a wireless signal addressed to the local station (hereinafter, referred to as “desired signal”), but also a wireless signal addressed to a different station (hereinafter, referred to as “undesired signal”) at a frequency close to the frequency of the desired signal.

In order to demodulate the desired signal accurately, the radio receiver is required to remove an undesired signal from the received signal, prior to inputting the received signal to a demodulator.

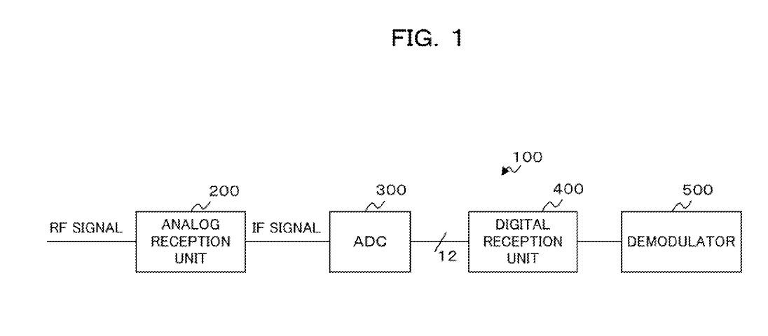

For this purpose, a typical radio receiver is configured as depicted in FIG. 1, for example.

FIG. 1 is a diagram illustrating an example of a typical radio receiver.

As depicted in FIG. 1, a radio receiver 100 includes, for example, an analog reception unit 200, an analog to digital converter (hereinafter, also referred to as “AD converter”) 300, a digital reception unit 400, and a demodulator 500.

The analog reception unit 200 performs predetermined reception processing on a reception signal. Such predetermined reception processing includes processing, such as filter processing, amplification of the signal, and frequency conversion.

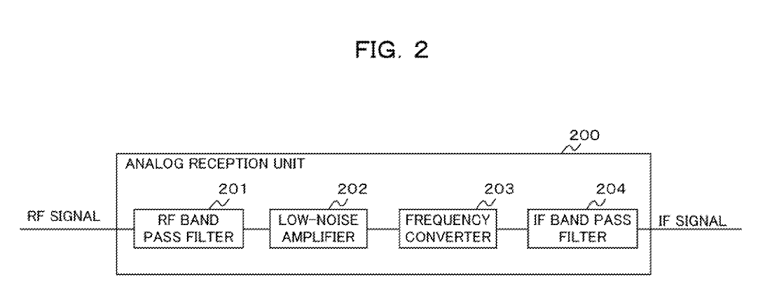

For this purpose, the analog reception unit 200 is configured as depicted in FIG. 2, for example.

FIG. 2 is a diagram illustrating an example of the configuration of the analog reception unit 200 in FIG. 1.

As depicted in FIG. 2, the analog reception unit 200 includes, for example, a radio frequency (RF) band pass filter 201, a low-noise amplifier 202, a frequency converter 203, and an intermediate frequency (IF) band pass filter 204.

The RF band pass filter 201 removes undesired wave signals at frequencies distant from the frequency of a desired signal by performing filter processing in a radio frequency band, on a received radio frequency signal (hereinafter, also referred to as “RF signal”).

The low-noise amplifier 202 amplifies the reception signal, from which the undesired wave signal is removed by the RF band pass filter 201, to a predetermined level.

The frequency converter 203 downconverts the signal output from the low-noise amplifier 202 to an intermediate frequency, by mixing it with a signal at a local oscillation frequency, and outputs the downconverted signal.

The IF band pass filter 204 removes undesired signals at frequencies near the frequency of a desired signal which cannot be removed by the RF band pass filter and unwanted signals generated in the mixing by the frequency converter 203, by performing filter processing in an intermediate frequency band, on the signal output from the frequency converter 203.

The signal filter-processed by the IF band pass filter 204 is then output to the AD converter 300, as an intermediate frequency signal (hereinafter, also referred to as “IF signal”).

That is, in the analog reception unit 200, the RF band pass filter 201 and the IF band pass filter 204 cooperatively remove the undesired signal.

On the other hand, the digital reception unit 400 in FIG. 1 performs digital processing on an input signal, and removes any undesired signal at a frequency that is very close to the frequency of the desired signal and accordingly cannot be completely removed in the analog reception unit 200.

More specifically, if the frequency of the undesired signal is close to the frequency of the desired signal, the RF band pass filter 201 and the IF band pass filter 204 may not be able to completely remove the undesired signal. Hence, the digital reception unit 400 removes any undesired signal at a frequency very close to the frequency of the desired signal, by means of a sharp filter provided in the digital reception unit 400.

The demodulator 500 performs predetermined demodulation processing on the signal output from the digital reception unit 400.

The AD converter 300, in order to digitize the analog signal, samples the analog signal output from the analog reception unit 200 at a certain time interval, and converts the amplitude of the signal into a digital value.

Since the signal input to the AD converter 300 does not undergo the reception processing by the digital reception unit 400, the undesired signal may not be removed completely.

In this case, the effect of undesired signals may become serious in the following scenario, for example.

A base station and a mobile station are communicating with each other, and the mobile station is located distant from the base station. In this case, a transmission signal sent from the mobile station is received at the base station at a low level.

If a transceiver compliant with a different wireless system is communicating near the base station and the power of that transceiver is strong, the signal of the second wireless system is received by the base station at a level higher than that of the transmission signal sent from the mobile station.

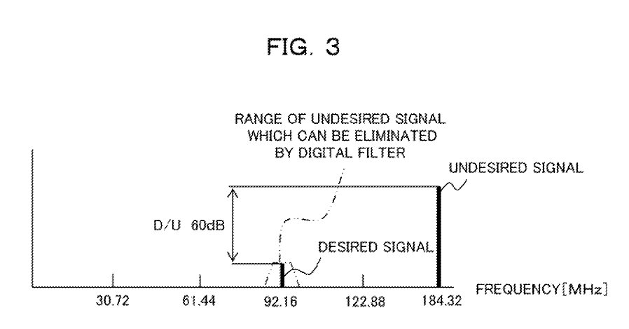

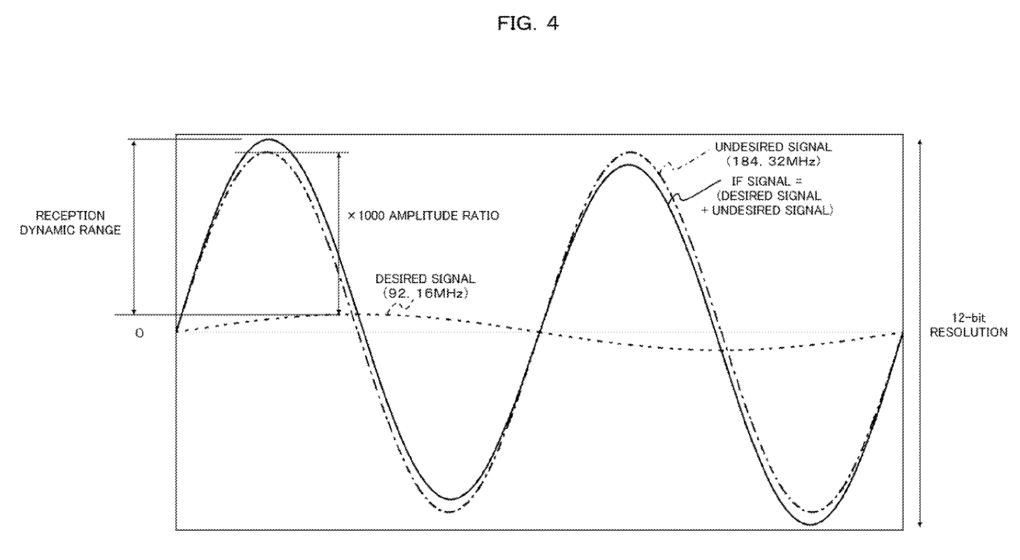

FIGS. 3 and 4 illustrate an example of the spectrum and waveform versus time plot of an IF signal input to the AD converter 300.

FIG. 3 is a diagram illustrating an example of a spectrum of the IF signal input to the AD converter 300.

For illustration, given that the frequency of a desired signal is 92.16 MHz, and the frequency of an undesired signal is 184.32 MHz, for example. The desired-to-undesired signal ratio (D/U) between the signals is 60 dB.

The undesired signal depicted in FIG. 3 cannot be completely removed by the RF band pass filter 201 and the IF band pass filter 204, and accordingly, is input to the AD converter 300.

FIG. 4 is a diagram illustrating an example of a waveform versus time plot of the IF signal input to the AD converter 300. Given that the resolution of the AD converter 300 is 12 bits, for example.

The vertical scale of the graph depicted in FIG. 4 is omitted for simplicity of illustration. The D/U between the desired and undesired signals is 60 dB, and accordingly, the amplitude of the undesired signal is 1000 times greater than that of the desired signal (20×log( 1000/1)=60 dB).

The desired signal intermixed with the undesired signal depicted in FIG. 4, is input to the AD converter 300.

In this case, the level of the signal containing the high-level undesired signal input to the AD converter 300 may exceed the maximum receivable range of the AD converter 300. Accordingly, upon designing a reception circuit in a radio receiver, the reception level of undesired signals, as well as the reception level of the desired signal, is required to be taken into account.

Further, when a high-level undesired signal is input, in order to digitize a desired signal that is weaker relative to the undesired signal, the AD converter 300 should have a sufficiently high resolution (a 12-bit AD converter may not be able to digitize a desired signal that is weak relative to undesired signals).

In this case, for a high-level undesired signal, the AD converter 300 is required to have a wider dynamic range.

Further, the dynamic range of the radio receiver 100 is determined by the dynamic range of the AD converter 300. Hence, in order to design a radio receiver 100 sufficiently resistant to undesired signals in the operating radio wave environment, an AD converter 300 having a sufficiently wider dynamic range should be selected.

However, the performance of AD converters 300 are somewhat limited.

An embodiment presents a solution to the above issue. Hereinafter, an embodiment will be described with reference to the drawings. Note that the embodiment described below is described by way of example only, and various modifications and applications of techniques that are not provided explicitly in the following embodiment and variations are not intended to be excluded. It is noted that the embodiment and variations can be modified in various manner without departing from the scope of the present disclosure.

### (1) Embodiment

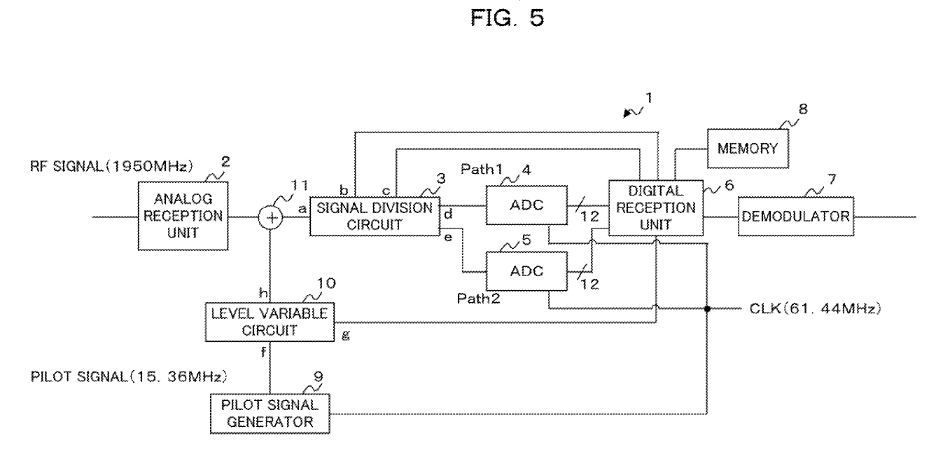

FIG. 5 is a diagram illustrating an example of the configuration of a radio receiver in accordance with an embodiment of the disclosure.

A radio receiver 1 depicted in FIG. 5, includes, for example, an analog reception unit 2, a signal division circuit (also referred to as “signal splitting circuit”) 3, AD converters 4 and 5, a digital reception unit 6, a demodulator 7, a memory 8, a pilot signal generator 9, a level variable circuit 10, and a pilot signal application unit 11.

The analog reception unit 2 performs predetermined reception processing on a reception signal. Such predetermined reception processing includes processing, such as filter processing, amplification of the signal, and frequency conversion.

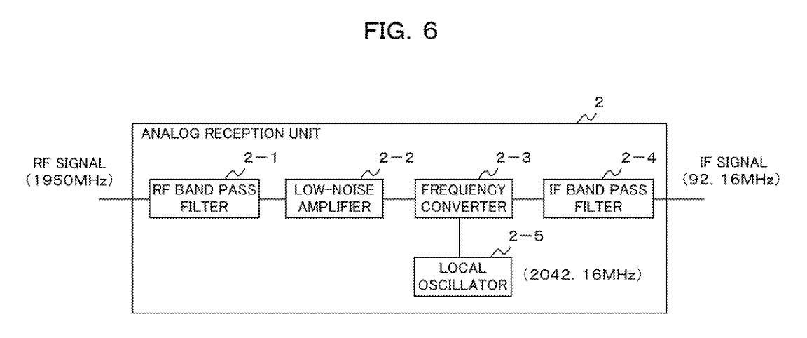

For this purpose, the analog reception unit 2 is configured as depicted in FIG. 6, for example.

FIG. 6 is a diagram illustrating an example of the configuration of the analog reception unit 2 in FIG. 5.

As depicted in FIG. 6, the analog reception unit 2 includes, for example, a radio frequency (RF) band pass filter 2-1, a low-noise amplifier 2-2, a frequency converter 2-3, an intermediate frequency (IF) band pass filter 2-4, and a local oscillator 2-5.

The RF band pass filter 2-1 removes undesired wave signals at frequencies distant from the frequency of a desired signal by performing filter processing in a radio frequency band, on a received radio frequency signal (hereinafter, also referred to as “RF signal”).

The low-noise amplifier 2-2 amplifies the reception signal, from which the undesired wave signal is removed by the RF band pass filter 2-1, to a predetermined level.

The frequency converter 2-3 downconverts the signal output from the low-noise amplifier 2-2 to an intermediate frequency, by mixing it with a signal at a local oscillation frequency output from the local oscillator 2-5, and outputs the downconverted signal.

The IF band pass filter 2-4 removes undesired signals at frequencies near the frequency of a desired signal which cannot be removed by the RF band pass filter and unwanted signals generated in the mixing by the frequency converter 2-3, by performing filter processing in an intermediate frequency band, on the signal output from the frequency converter 2-3.

The local oscillator 2-5 generates a signal at a local oscillation frequency, and outputs the generated signal to the frequency converter 2-3.

More specifically, the RF signal input to the analog reception unit 2 is downconverted to an intermediate frequency and is output as an IF signal.

The signal division circuit 3 divides the IF signal output from the analog reception unit 2 into a positive-side signal and a negative-side signal, and outputs the divided positive- and negative-side signals to a path 1 and a path 2, respectively. That is, the signal division circuit 3 functions as an example of a signal divider that divides an intermediate frequency signal obtained by downconverting a radio frequency signal received at an analog reception circuit, into a plurality of (two, in this example) signal fragments based on an amplitude, and outputs the signal segments, as well as functioning as an example of a signal division circuit comprising an input section that receives the intermediate frequency signal and two output sections that divide the intermediate frequency signal received through the input section into two signal fragments based on the amplitude, and output the signal fragments.

The analog to digital converters (AD converters) 4 and 5 digitize an input analog signal by sampling the analog signal at a certain time interval and convert the amplitude of the signal into a digital value. That is, the AD converters 4 and 5 function as an example of a plurality of analog to digital converters that perform an analog to digital conversion on the respective signal fragments divided by the signal divider, and output the signal fragments toward a digital reception circuit.

The AD converter 4 is an AD converter provided on the path 1, which converts the positive-side signal output from the signal division circuit 3 into a digital signal, and outputs the converted digital signal.

The AD converter 5 is an AD converter provided on the path 2, which converts the negative-side signal output from the signal division circuit 3 into a digital signal, and outputs the converted digital signal.

The AD converters 4 and 5 are supplied with clock signals (CLKs) at the identical frequency.

As an example, the AD converters 4 and 5 each have a resolution of 12 bits, for the sake of illustration.

The digital reception unit 6 combines digital signals output from the AD converters 4 and 5, and performs predetermined digital processing, such as filter processing by means of a digital filter.

Since signal processing is simplified after digitizing the signal by the AD converter 5, the digital reception unit 6 can process the input signal in any form, and output the processed signal to the demodulator 7.

The demodulator 7 performs predetermined demodulation processing on the signal output from the digital reception unit 6.

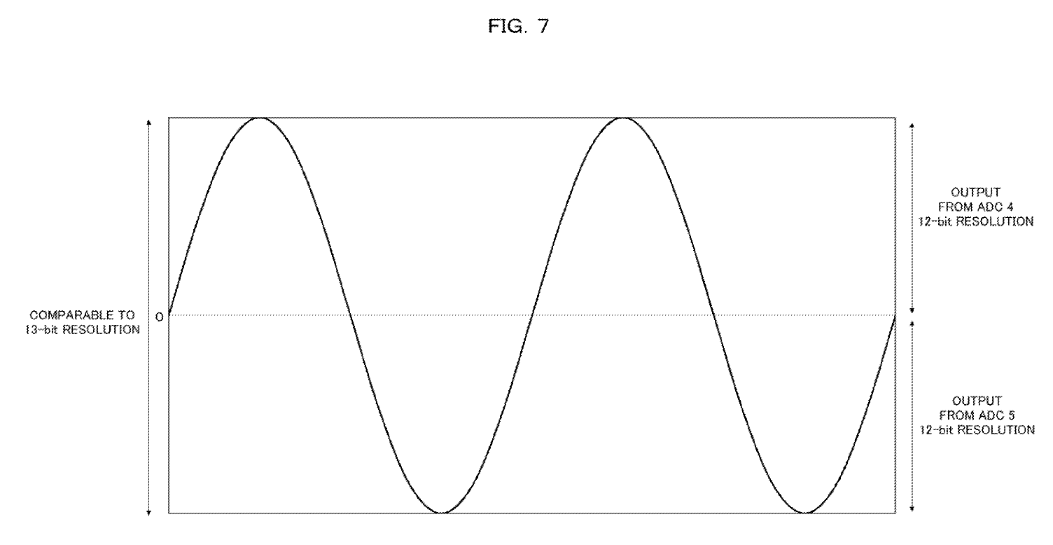

FIG. 7 is a diagram illustrating a waveform versus time plot of the signals combined in the digital reception unit 6. It is noted that signals handled by the digital reception unit 6 are digital signals and their signal waveforms are expressed with envelopes (this applies to the following description).

In the above configuration, the signal division circuit 3 divides the IF signal output from the analog reception unit 2 into positive- and negative-side signals and outputs them, and the AD converters 4 and 5 having a resolution of 12 bits then convert the positive- and negative-side signals into digital signals. Hence, the amplitude range of the AD converters 4 and 5 are sufficient to be as small as a half of the amplitude of the IF signal output from the analog reception unit 2.

Thereby, the amplitude range of reception signals which can be processed by the radio receiver 1 is doubled, and the resolution of the radio receiver 1 is equivalently two times greater than 2¹² (12 bits), namely, 2¹³ (13 bits).

It is noted that the signal division circuit 3 may be constructed from a push-pull circuit, for example.

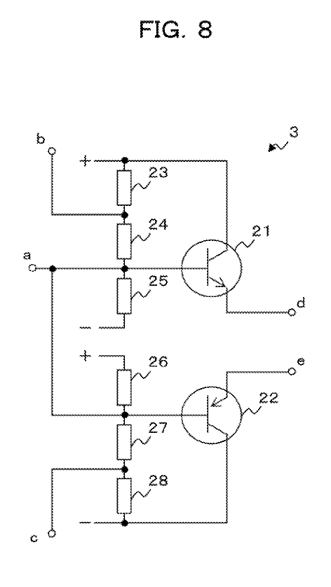

FIG. 8 is a diagram illustrating an example of the configuration of the signal division circuit 3 depicted in FIG. 5.

The signal division circuit 3 depicted in FIG. 8 is embodied using a push-pull circuit including transistors 21 and 22 and resistors 23 to 28, for example.

It is noted that terminals “a” to “e” in FIG. 8 correspond to the terminals “a” to “e” in FIG. 5, respectively.

The transistor 21 is configured as a PNP transistor, and the transistor 22 is configured as an NPN transistor. It is noted that these bipolar transistors may be replaced with other semiconductor devices, such as field effect transistors (FETs).

In the signal division circuit 3 depicted in FIG. 8, in response to a signal being input to the terminal “a”, the transistor 21 turns on and transistor 22 turns off, if the input signal is positive with respect to the zero amplitude.

On the other hand, the transistor 22 turns on and the transistor 21 turns off, if the input signal is negative with respect to the zero amplitude.

As a result, only the positive side of the signal input to the terminal “a” is output to the terminal “d”, and only the negative side of the signal input to the terminal “a” is output to the terminal “e”.

As described above, the function of the signal division circuit 3 can be embodied using the push-pull circuit.

However, when the signal division circuit 3 is embodied using the push-pull circuit depicted in FIG. 8, the output waveform is deformed near the zero amplitude affected by the base ON voltages of the transistors 21 and 22.

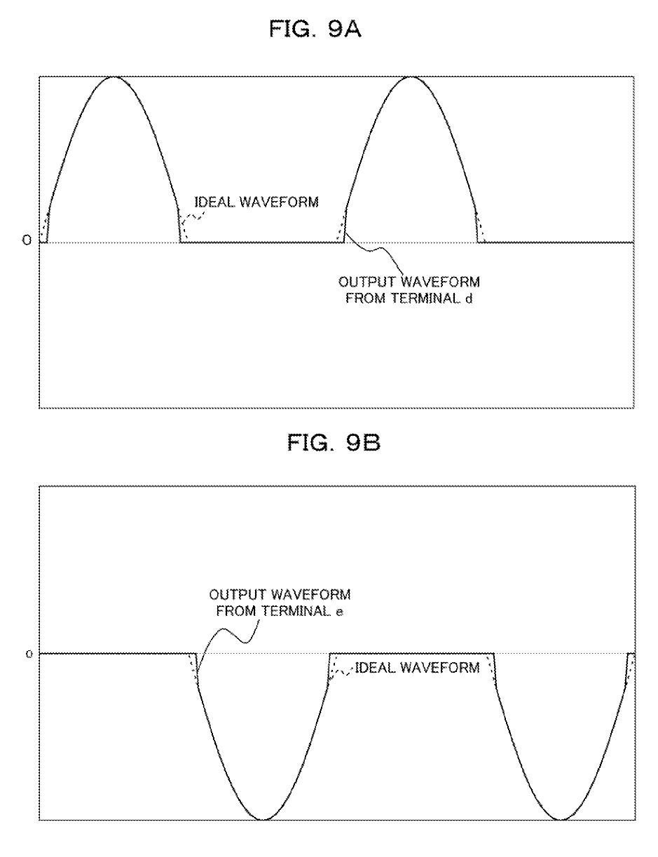

FIG. 9A is a diagram illustrating the waveform versus time plot of a signal output from the terminals “d” of the signal division circuit 3 embodied using a push-pull circuit, FIG. 9B is a diagram illustrating the waveform versus time plot of a signal output from the terminals “e” of the signal division circuit 3 embodied using a push-pull circuit.

As depicted in FIGS. 9A and 9B, the waveforms of signals output from the terminals “d” and “e” of the signal division circuit 3 (indicated by the solid lines in FIGS. 9A and 9B) deform near the zero amplitude. These waveforms are altered from the waveform of the IF signal that has been input to the signal division circuit 3 (indicated by the broken line in FIGS. 9A and 9B; referred to as the “ideal waveform”).

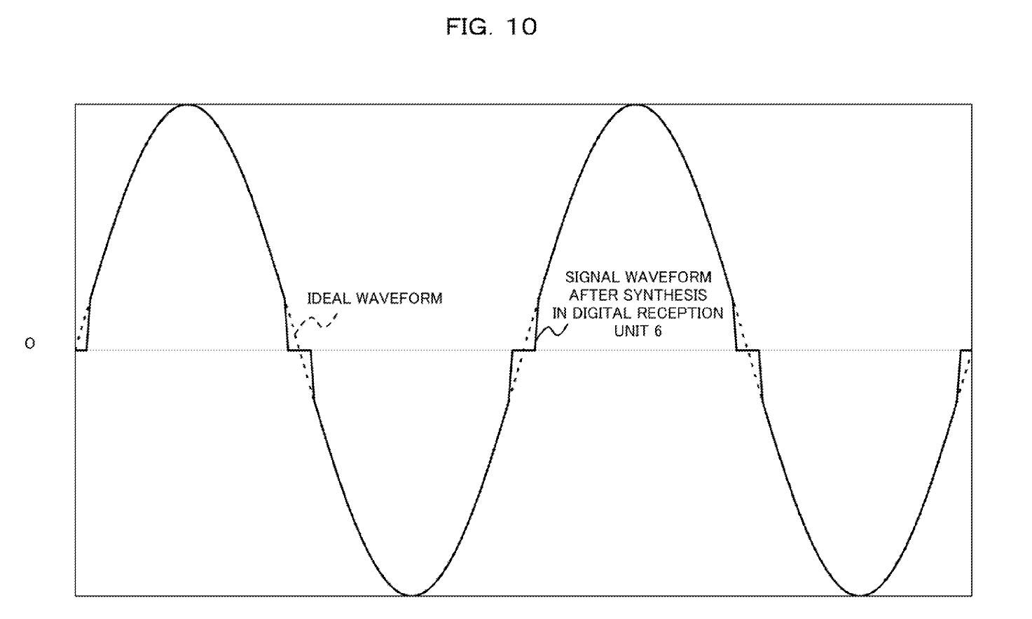

FIG. 10 is a diagram illustrating a waveform versus time plot of a signal combined in the digital reception unit 6, when the signal division circuit 3 is embodied using a push-pull circuit.

When such waveform-distorted signals are combined in the digital reception unit 6, unlike the continuous waveform of the IF signal input to the signal division circuit 3, the waveform of the combined signal contains discontinuities near the zero amplitude (hereinafter, such discontinuities are also referred to as “signal division boundaries”).

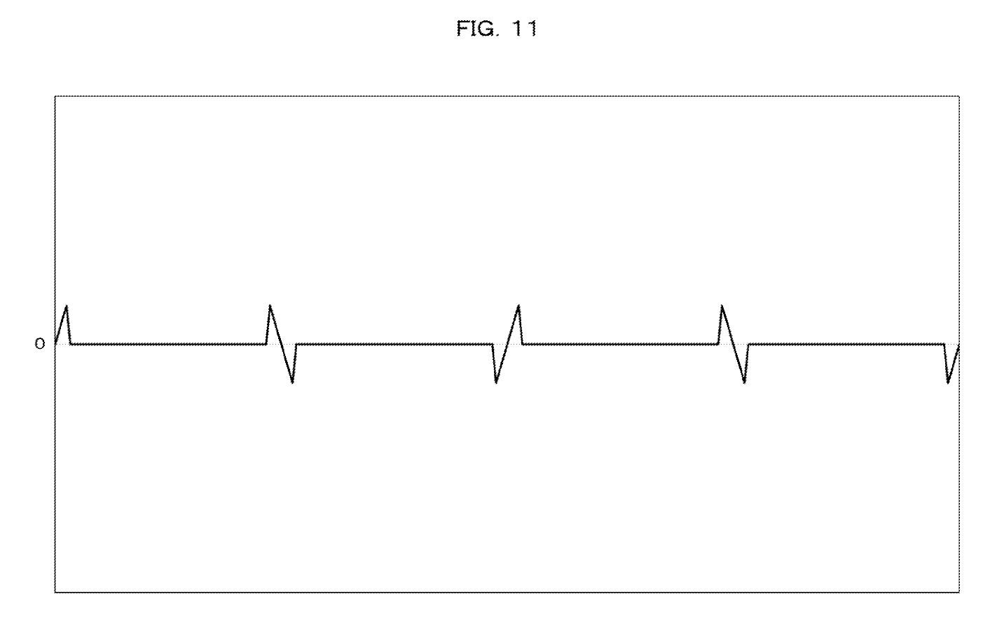

The waveform distortions in the discontinuities of the signal may cause the error signals depicted in FIG. 11, and the demodulator 7 is unable to demodulate the received signal correctly.

In the present embodiment, in order to suppress such waveform distortions, the digital reception unit 6 outputs a control voltage for the path 1 (hereinafter “path 1 control voltage”) and a control voltage for the path 2 (hereinafter “path 2 control voltage”), to the terminals “b and “c” of the signal division circuit 3, respectively, as well as having the functions as set forth above. The control voltages alter the base voltages of the transistors 21 and 22 in the signal division circuit 3, thereby correcting the waveform distortion.

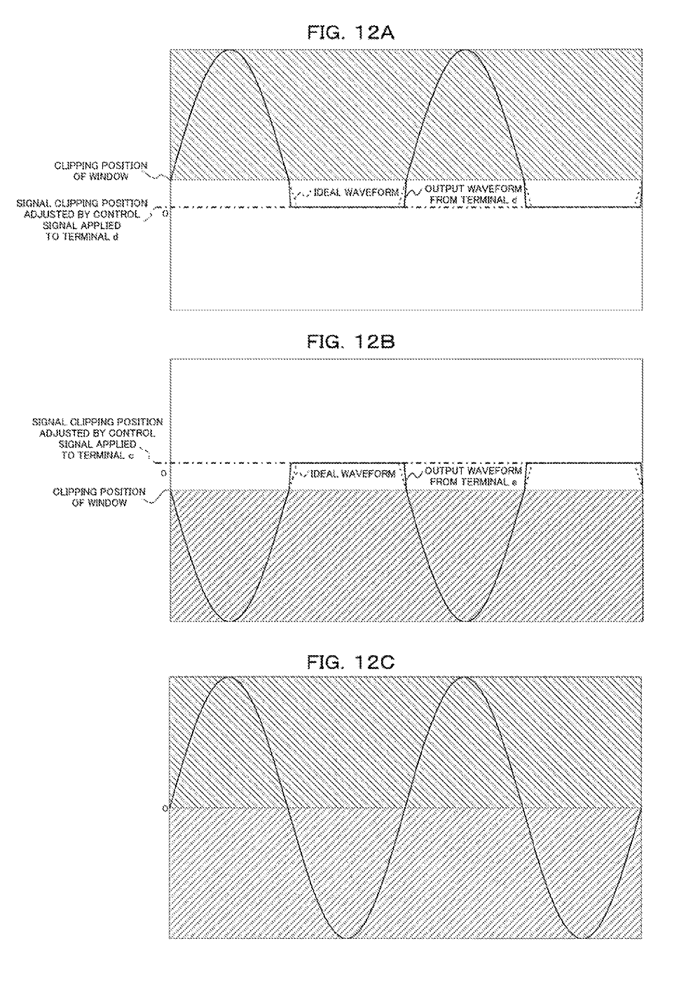

FIGS. 12A to 12C are diagrams illustrating a method of correcting a waveform distortion.

FIG. 12A illustrates a waveform versus time plot of a signal output from the terminal “d” when the path 1 control voltage is applied to the terminal “b” of the signal division circuit 3.

The digital reception unit 6 changes the base voltage of the transistor 21 by adjusting the path 1 control voltage applied to the terminal “b” of the signal division circuit 3, thereby adjusting the position where the signal output from the terminal “d” is clipped to the position, as indicated by the dot-and-dash line in FIG. 12A.

The signal output from the terminal “d” of the signal division circuit 3 is then converted into a digital signal in the AD converter 4, and is input to the digital reception unit 6.

Here, the digital reception unit 6 can extract a positive-side signal free from any waveform distortion by clipping the waveform output from the AD converter 4 at the position where the waveform is not distorted (hatched area in FIG. 12A) using a predetermined window.

FIG. 12B illustrates a waveform versus time plot of a signal output from the terminal “e” when the path 2 control voltage is applied to the terminal “c” of the signal division circuit 3.

For the signal output from the terminal “e”, a negative-side signal without any waveform distortion (hatched area in FIG. 12B) can be extracted by performing processing similar to the processing on the signal output from the terminal “d.

Then, a waveform-undistorted signal as in FIG. 12C can be obtained by combining the resultant positive- and negative-side signals, in the digital reception unit 6.

However, the push-pull circuit described above includes the transistors 21 and 22, which are analog devices as depicted in FIG. 8, and their base ON voltages deviate under the influence of the ambient temperature, deterioration over time, and the like.

As a result, the optimum values for path 1 control voltage and path 2 control voltage also deviate.

To address this issue, in the present embodiment, any deviation of the properties of the transistors 21 and 22 are monitored using a pilot signal. Based on the result of the monitoring, the path 1 control voltage and the path 2 control voltage are then adjusted.

The pilot signal generator 9 generates a pilot signal from a clock signal (CLK), and can be embodied using a frequency divider, for example. In the present embodiment, the pilot signal generator 9 is embodied using a frequency divider which divided the clock signal by four.

The level variable circuit 10 adjusts the level of the pilot signal output from the pilot signal generator 9, and is controlled by means of a pilot signal level control voltage output from the digital reception unit 6.

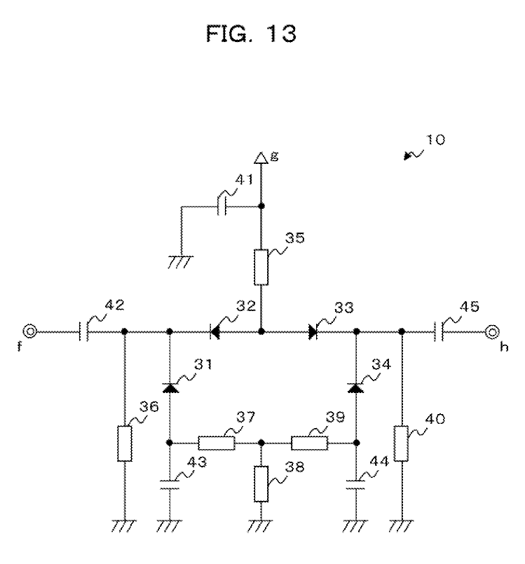

It is noted that the level variable circuit 10 can be embodied by a circuit depicted in FIG. 13, for example.

FIG. 13 is a diagram illustrating an example of the configuration of a level variable circuit depicted in FIG. 5.

More specifically, the level variable circuit 10 includes diodes 31 to 34, resistors 35 to 40, and the capacitors 41 to 45.

It is noted that terminals “f” to “h” in FIG. 13 correspond to the terminals “f” to “h” in FIG. 5, respectively.

The level variable circuit 10 depicted in FIG. 13 can vary the bias voltage to the diodes 31 to 34 by adjusting the pilot signal level control voltage applied to the terminal “g” to adjust the resistor value of the diode, thereby adjusting the magnitude of the attenuation between the terminal “f” and the terminal “h”.

That is, the pilot signal generator 9 and the level variable circuit 10 function as an example of a pilot signal generator that generates a pilot signal having a frequency different from a frequency of the intermediate frequency signal.

The pilot signal application unit 11 adds the pilot signal to the IF signal output from the analog reception unit 2, and outputs the resultant signal to the signal division circuit 3.

Hereinafter, a method of correcting a time-induced deviation for the radio receiver 1 by means of the pilot signal will be described. It is noted that the example presented in the present embodiment is merely exemplary, and the conditions, such as the signal frequency and the signal level, are not limited to the example described here.

For correcting a time-induced deviation in the radio receiver 1, firstly, a reference level for the pilot signal is stored, by performing a calibration. This calibration will be described first

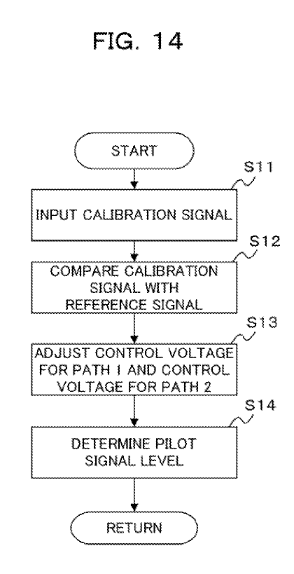

FIG. 14 is a diagram illustrating a flow for the calibration.

First, as a calibration signal, a sinusoidal wave, which is to be downconverted to 92.16 MHz later, is input to an input end of the analog reception unit 2 (hereinafter, simply referred to as “input end”) (see Step S11 in FIG. 14). That is, this calibration signal is a sinusoidal wave signal having the same frequency as that of the IF signal. Given that the level of the calibration signal at the input end is −110 dBm, for example.

At this time, the level variable circuit 10 is turned off (the pilot signal level control voltage applied to the terminal “g” of the level variable circuit 10 is set to 0 V), such that no pilot signal is added to the IF signal.

The calibration signal is divided by the signal division circuit 3, and the resultant signals are then converted into digital signals by the AD converters 4 and 5. At this time, the AD converters 4 and 5 sample the respective signals at 61.44 MHz, which is the frequency of the clock signal.

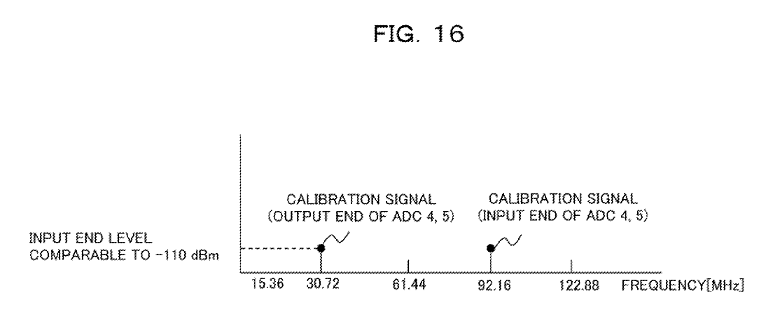

FIG. 16 is a diagram illustrating a spectrum of the calibration signal at the input and output ends of the AD converters 4 and 5.

Since the calibration signal is sampled by the AD converters 4 and 5 at 61.44 MHz, the signals output from the AD converters 4 and 5 have a frequency of 30.72 MHz.

Then, the level of the calibration signal is compared against the level of a reference signal (see Step S12 in FIG. 14).

The memory 8 stores a reference signal used as a reference (the reference signal contains reference value information), and the digital reception unit 6 reads the reference signal from the memory 8 when necessary. That is, the memory 8 functions as an example of a storage that stores reference value information.

The reference signal is an ideal output level that should be observed at the digital reception unit 6 when a signal with −110 dBm is input to the input end, for example.

It is noted that the properties of a radio receiver 1 may be tested in a performance test to check the properties of the internal components after designing a radio receiver 1, and the reference signal may be determined based on the properties. The reference signal may be stored in the memory 8 in advance, as a factory setting of the radio receiver 1.

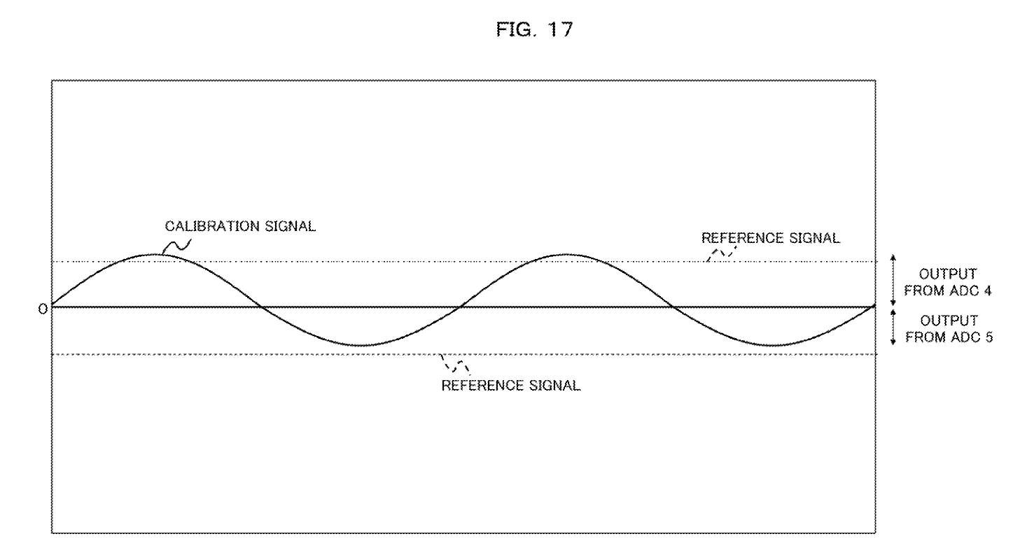

FIG. 17 is a diagram illustrating a waveform versus time plot of the calibration and reference signals in the digital reception unit 6 depicted in FIG. 5.

The digital reception unit 6 then sets the path 1 control voltage and the path 2 control voltage such that the level of the calibration signal matches the level of the reference signal (see Step S13 in FIG. 14).

The positive-side amplitude of the calibration signal is adjusted by adjusting the path 1 control voltage, thereby adjusting the base voltage of the transistor 21.

The negative-side amplitude of the calibration signal is adjusted by adjusting the path 2 control voltage, thereby adjusting the base voltage of the transistor 22.

In the example depicted in FIG. 17, the positive-side amplitude of the calibration signal exceeds the level of the reference signal, and accordingly, the digital reception unit 6 adjusts the path 1 control voltage such that the positive-side amplitude of the calibration signal is reduced.

On the other hand, the negative-side amplitude of the calibration signal is smaller than the level of the reference signal, and accordingly, the digital reception unit 6 adjusts the path 2 control voltage such that the negative-side amplitude of the calibration signal is increased.

In addition, the digital reception unit 6 also determines the position where to clip the window (window clip position).

The path 1 control voltage and the path 2 control voltage and the window clip position determined as described above are stored in the memory 8.

Then, the level of the pilot signal is determined (see Step S14 in FIG. 14).

The level variable circuit 10 in FIG. 5 is turned on (that is, the digital reception unit 6 applies a positive voltage to the level variable circuit 10 depicted in FIG. 13), such that a pilot signal is input to the pilot signal application unit 11.

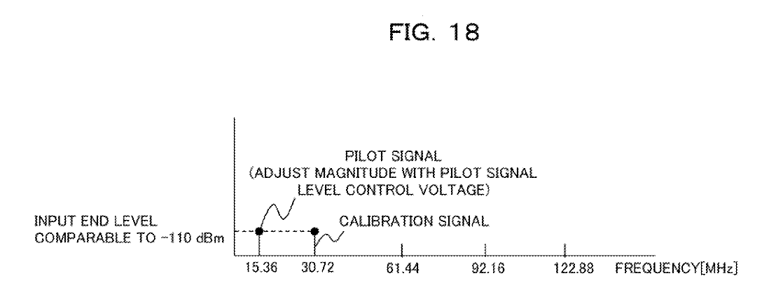

FIG. 18 is a diagram illustrating spectra of the pilot and calibration signals in the digital reception unit 6 depicted in FIG. 5.

Since the pilot signal generator 9 generates a pilot signal by dividing the clock signal at 61.44 MHz by four, the pilot signal has a frequency of 15.36 MHz.

The digital reception unit 6 adjusts the pilot signal level control voltage output to the level variable circuit 10 such that the level of the pilot signal in FIG. 18 has the same level as that of calibration signal.

The digital reception unit 6 stores the magnitude of the pilot signal level control signal adjusted as described above (that is, the level of the pilot signal to be referenced to later) as a reference value, into the memory 8 in FIG. 5. That is, the digital reception unit 6 functions as an example of a corrector that compares the reference value information and the pilot signal, and corrects a time-induced deviation in a signal division boundary in the signal divider.

The calibration is completed at this step.

While the radio receiver 1 is being operated, a time-induced deviation may be generated at the signal division boundaries due to a deviation in the ambient temperature, degradation over time, and the like. Thus, the time-induced deviation in the signal division boundaries is corrected in this embodiment.

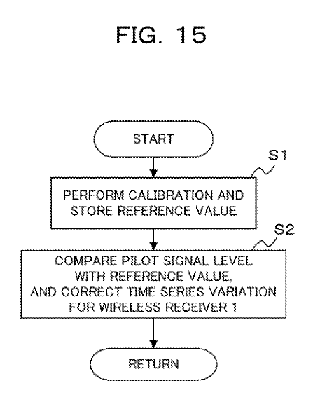

More specifically, as depicted in FIG. 15, before operating the radio receiver 1, the signal level of the pilot signal that is obtained in the above-described calibration, to be used as a reference value later, is stored (see Step S1 in FIG. 15). Then during operation of the radio receiver 1, the pilot signal level and the reference value are compared against with each other to correct any time-induced deviation in the radio receiver 1 (see Step S2 in FIG. 15).

In this example, given that only a desired signal is received as an RF signal, for the simplicity of illustration.

During startup of the radio receiver 1, a pilot signal is input to the pilot signal application unit 11.

While the pilot signal is being input, the RF signal is input to the input end. Here, the RF signal is a signal which is to be downconverted to have a center frequency of 92.16 MHz, and is modulated having a bandwidth of 20 MHz.

Therefore, the IF signal having a center frequency of 92.16 MHz and a bandwidth of 20 MHz and the pilot signal at 15.36 MHz are input to the signal division circuit 3.

Since the AD converters 4 and 5 sample at a sampling frequency of 61.44 MHz, the IF signal having a center frequency of 92.16 MHz is converted by the AD converters 4 and 5 and digital signals having a center frequency of 30.72 MHz are output.

It is noted that the pilot signal still has a frequency of 15.36 MHz even after being sampled by the AD converters 4 and 5.

That is, the pilot signal at 15.36 MHz and the digital signal at 30.72 MHz are input to the digital reception unit 6.

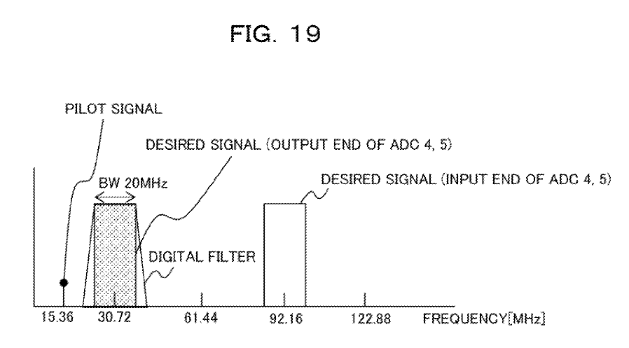

FIG. 19 is a diagram illustrating spectra of a desired signal at the input ends of the AD converters and respective signals observed in the digital reception unit 6 during operation of the radio receiver 1 depicted in FIG. 5.

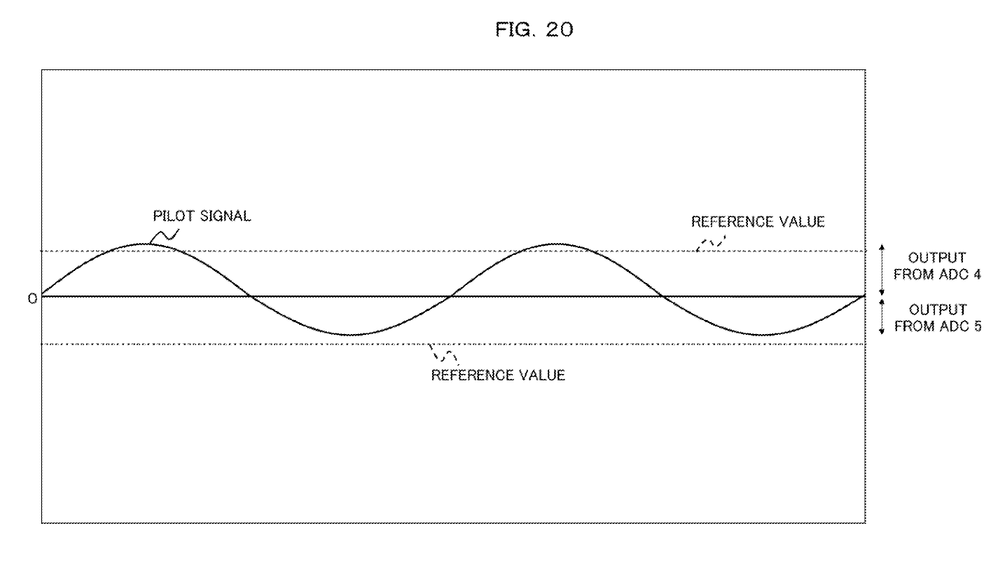

FIG. 20 is a diagram illustrating a waveform versus time plot of a pilot signal observed in the digital reception unit 6 during operation of the radio receiver 1 depicted in FIG. 5.

When the signal clip position by the base voltage of the transistors 21 and 22 deviates due to deviation in the ambient temperature and the like, the level of the pilot signal also deviates.

The digital reception unit 6 constantly monitors the pilot signal during operation of the radio receiver 1. Thus, when the level of the pilot signal deviates, the digital reception unit 6 changes the path 1 control voltage and the path 2 control voltage such that the level of the pilot signal matches or substantially matches the reference value.

For example, in the example depicted in FIG. 20, the level of the pilot signal output from the AD converter 4 exceeds the reference value, and accordingly, the digital reception unit 6 adjusts the path 1 control voltage such that the level of the pilot signal output from the AD converter 4 is decreased.

On the other hand, the level of the pilot signal output from the AD converter 5 is smaller than the reference value, and accordingly, the digital reception unit 6 adjusts the path 2 control voltage such that the level of the pilot signal output from the AD converter 5 is increased.

As described above, since the path 1 control voltage and the path 2 control voltage are adjusted such that the level of the pilot signal has the level matches or substantially matches the reference value at any time, the signal clip position by the base voltage of the transistors 21 and 22 is maintained to an optimal position at any time.

In other words, the radio receiver 1 maintains the clip position to the optimum position autonomously, even when the ambient temperature deviates during operation, for example.

It is noted that the digital reception unit 6 removes the pilot signal and an undesired signal using a digital filter with 20-MHz bandwidth, prior to outputting only the desired signal to the demodulator 7.

As set forth above, in accordance with the present embodiment, the signal division circuit 3 divides an IF signal into positive- and negative-side signals, and then the AD converters 4 and 5 convert the respective positive- and negative-side signals into digital signals. Hence, the dynamic range of the radio receiver can be expanded without requiring any complex circuit or expensive AD converter.

Further, the digital reception unit 6 outputs a path 1 control voltage and a path 2 control voltage to the signal division circuit 3 to adjust the signal clip position, for removing any waveform distortion components using a window. Hence, waveform distortions are suppressed even when the signal division circuit 3 is embodied using a push-pull circuit.

Furthermore, any deviation in the circuit properties is monitored using a pilot signal, and the signal clip position for the signal division circuit is autonomously adjusted to accommodate for the deviation of the circuit properties. As a result, stable reception properties can be achieved.

### (2) First Variation

A radio receiver including an increased number of AD converters may be embodied by configuring signal division circuits 3 in accordance with an embodiment in a multiple-stage configuration.

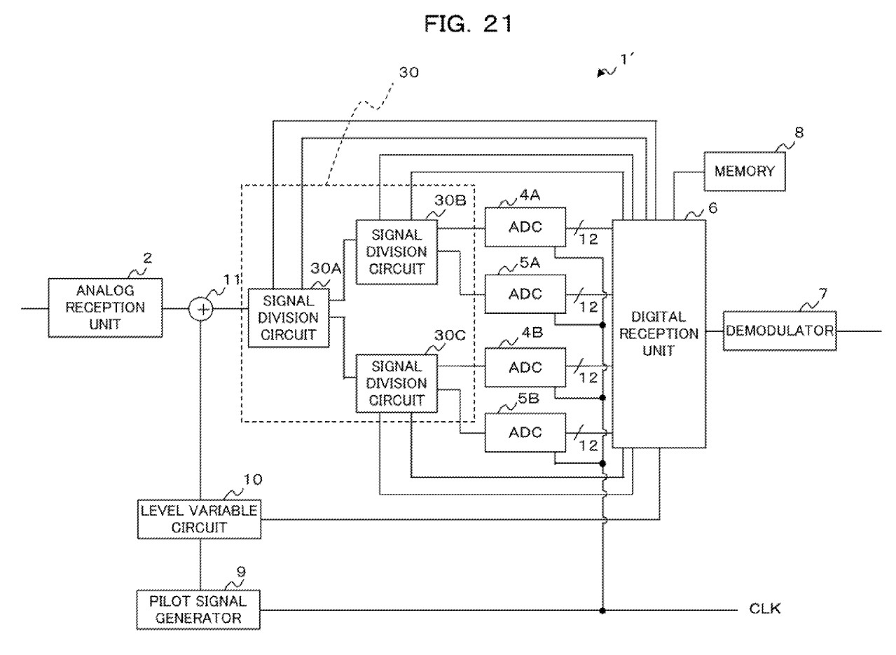

FIG. 21 is a diagram illustrating an example of the configuration of a radio receiver 1′ in accordance with a first variation.

A radio receiver 1′ depicted in FIG. 21 includes, for example, an analog reception unit 2, a signal division circuit 30, AD converters 4A, 4B, 5A and 5B, a digital reception unit 6, a demodulator 7, a memory 8, a pilot signal generator 9, a level variable circuit 10, and a pilot signal application unit 11. It is noted that components in FIG. 21 referenced to by the same reference symbols as those described previously have the similar functions as their counterparts, and any description therefor will be omitted.

The signal divider 30 includes signal division circuits 30A, 30B, and 30C having the same configuration, and has a signal division circuit unit configuration wherein the respective input sections of a pair of signal division circuits 30B and 30 are connected to two output sections of the signal division circuit 30A on the signal upstream side.

The signal division circuit 30A divides an IF signal output from the analog reception unit 2 into positive- and negative-side signals, with respect to the zero amplitude.

The signal division circuits 30B and 30C are connected to the respective output ends of the signal division circuit 30A, and further divide positive- and negative-side signals output from the signal division circuit 30A, respectively.

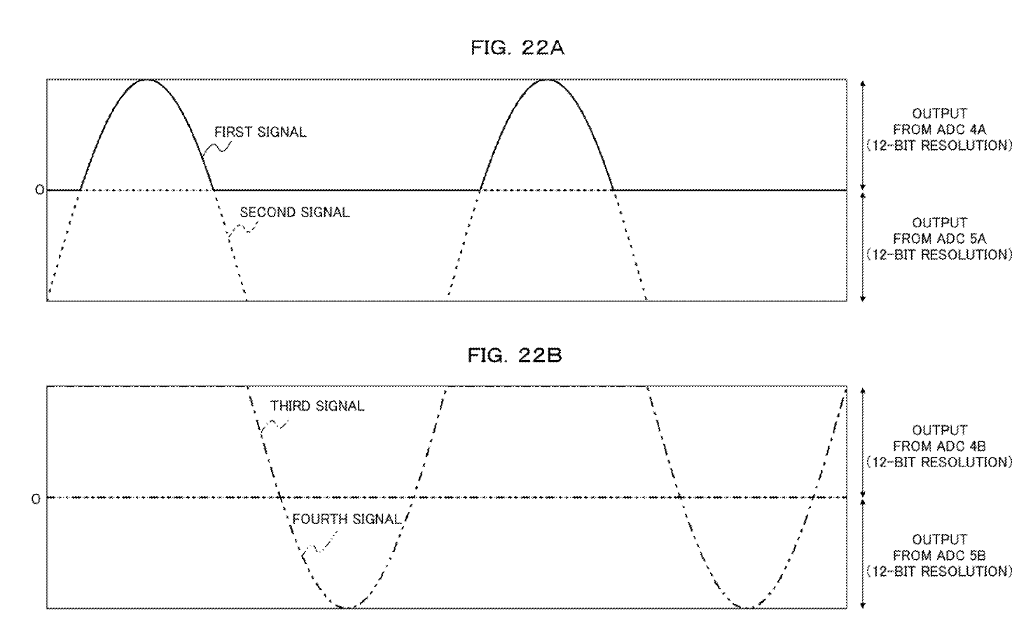

FIGS. 22A and B are diagrams illustrating waveform versus time plots of the respective signals output from the signal division circuits 30B and 30C.

FIG. 22A depicts the waveform versus time plot of the signal output from the signal division circuit 30B.

The signal division circuit 30B divides the positive-side signal output from the signal division circuit 30A into first and second signals, with respect to a half of the maximum amplitude of the positive-side signal.

FIG. 22B depicts the waveform versus time plot of the signal output from the signal division circuit 30C.

The signal division circuit 30C divides the negative-side signal output from the signal division circuit 30A into third and fourth signals, with respect to a half of the maximum amplitude of the negative-side signal.

That is, the AD converters 30A-30C, working cooperatively, function as an example of a signal divider that divides an intermediate frequency signal obtained by downconverting a radio frequency signal received at an analog reception circuit, into a plurality of signal fragments based on an amplitude, and outputs the signal segments. Further, each of the AD converters 30A-30C functioning as an example of a signal division circuit comprising an input section that receives the intermediate frequency signal and two output sections that divide the intermediate frequency signal received through the input section into two signal fragments based on the amplitude, and output the signal fragments.

The resultant first to fourth signals are converted into digital signals by the AD converters 4A, 5A, 4B, and 5B.

In accordance with the above-described configuration, the signal division circuits 30A-30C divide the IF signal output from the analog reception unit 2 into first to fourth signals and output the divided signals. The AD converters 4A, 5A, 4B, and 5B having a resolution of 12 bits then convert the first to fourth signals into digital signals, respectively. Hence, the amplitude range of the AD converters 4A, 5A, 4B, and 5B are sufficient to be as small as a quarter of the amplitude of the IF signal output from the analog reception unit 2.

Thereby, the amplitude range of reception signals which can be processed by the radio receiver 1 is quadrupled, and the resolution of the radio receiver 1 is equivalently four times greater than 2¹² (12 bits), namely, 2¹⁴ (14 bits).

As described above, in accordance with the present variation, by providing signal division circuits in a multiple-stage configuration to increase the number of AD converters, the resolution of the radio receiver can be further enhanced.

It is noted that the signal division circuits 30A-30C may be embodied with push-pull circuits depicted in FIG. 8, as in the above-described embodiment.

In such a case, the digital reception unit 6 can suppress any waveform distortions by applying control voltages to the signal division circuits 30A-30C, in the manner similar to the above-described embodiment.

Further, by monitoring any deviation in the properties of the respective transistors in the signal division circuits 30A-30C by means of a pilot signal, it is possible to maintain the control voltages applied to the signal division circuits 30A-30C to optimum values at any time.

### (3) Second Variation

In the above embodiment and the first variation thereto, in a case wherein the operation environment of the radio receiver 1 or 1′ is stable, it is possible to further simplify the circuit configuration.

Although this variation will be described to include one signal division circuit and two AD converters as in the above embodiment, it may be applied to other configurations, such as a configuration having three signal division circuits and four AD converters as in the first variation, or a configuration having more signal division circuits and more AD converters.

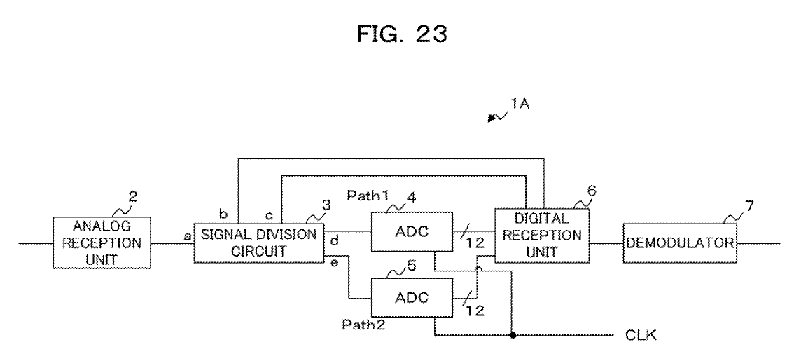

FIG. 23 is a diagram illustrating an example of the configuration of a radio receiver 1A in accordance with a second variation.

The radio receiver 1A depicted in FIG. 23 includes, for example, an analog reception unit 2, a signal division circuit 3, AD converters 4 and 5, a digital reception unit 6, and a demodulator 7.

In other words, the radio receiver in accordance with the second variation can be configured without a memory 8, a pilot signal generator 9, a level variable circuit 10, and a pilot signal application unit in a radio receiver 1 depicted in FIG. 5.

In accordance with the present variation, since the circuit configuration of the radio receiver can be simplified in this manner, various advantages, such as power conservation, space reduction, and the cost reduction of a radio receiver, are achieved.

### (4) Third Variation

In the second variation, if the signal division circuit 3 can be embodied with an ideal half-wave rectifier circuit, thereby suppressing any waveform distortion components, the circuit configuration can be simplified even further.

Although this variation will be described to include one signal division circuit and two AD converters as in the above embodiment, it may be applied to other configurations, such as a configuration having three signal division circuits and four AD converters as in the first variation, or a configuration having more signal division circuits and more AD converters.

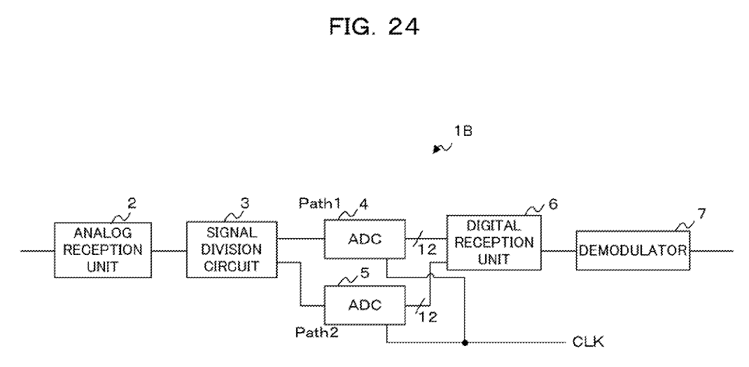

FIG. 24 is a diagram illustrating an example of the configuration of a radio receiver 1B in accordance with a third variation.

The radio receiver 1B depicted in FIG. 24 includes, for example, an analog reception unit 2, a signal division circuit 3, AD converters 4 and 5, a digital reception unit 6, and a demodulator 7.

The digital reception unit 6 in the radio receiver according to the third variation includes only a function to combine signals output from the AD converters 4 and 5 and a function to perform predetermined digital processing, such as filtering by means of a digital filter.

Stated differently, a function to output a control voltage to the signal division circuit 3 for correcting any waveform distortion generated in the signal division circuit 3 and a function to clip the waveform distortion from signals output from the AD converters 4 and 5 using a window, may be omitted.

As described above, in accordance with the present variation, the processing load of the radio receiver can be mitigated.

### (5) Others

In the above-described embodiment and the variations thereto, the analog reception unit 2, the signal division circuit(s) 3 or 30A-30C, the pilot signal generator 9, the level variable circuit 10, and the pilot signal application unit 11 may be embodied by suitably combining various types of analog circuits (analog units). The digital reception unit 6 and the demodulator 7 may be embodied using a DSP or a CPU (digital units).

Furthermore, the components, steps, and functions of the radio receivers 1, 1′, 1A, and 1B may be suitably omitted or incorporated, or may be combined appropriately. In other words, the components and functions described above may be appropriately selected or combined together such that the functions of the disclosed technique is achieved.

Further, the components, steps, and functions of the radio receivers 1, 1′, 1A, and 1B may be used appropriately to configure a radio base station apparatus (for example, a smaller base station apparatus used for a femtocell).

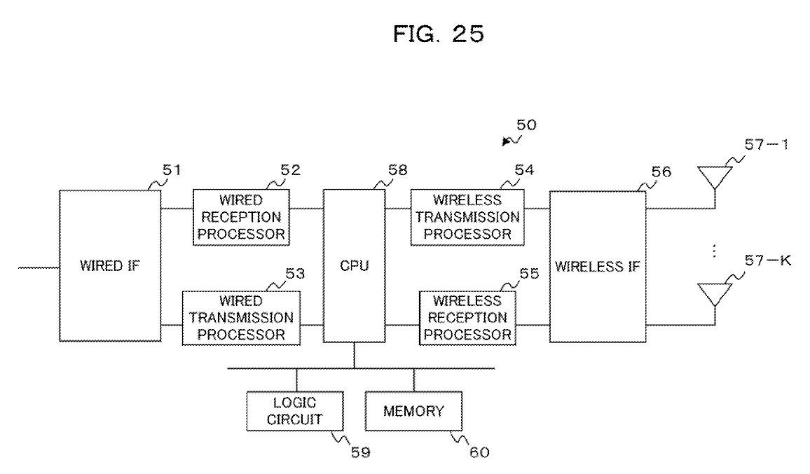

FIG. 25 is a diagram illustrating the configuration of a radio base station apparatus wherein a radio receiver 1, 1′, 1A, or 1B according to any of the above-described embodiment and the variations is applied.

A radio base station apparatus 50 depicted in FIG. 25 includes, for example, a wired interface (IF) 51, a wired reception processor 52, a wired transmission processor 53, a wireless transmission processor 54, a wireless reception processor 55, a wireless interface 56, and K (K is a natural number of one or more) antennas 57-1 to 57-K, a CPU 58, a logic circuit 59, and a memory 60. Note that, in the following description, the antennas 57-1 to 57-K may be collectively referred to as “antenna 57” when no distinction among them is made.

The wired interface 51 controls communications between the radio base station apparatus 50, and an external network or an upper apparatus.

The wired reception processor 52 performs predetermined signal processing on a signal input from the wired interface 51, such as demodulation processing and decode processing.

The wired transmission processor 53 performs predetermined signal processing on a signal to be sent to the external network or upper apparatus, such as encode processing and modulation processing.

The wireless transmission processor 54 performs predetermined signal processing on a signal to be sent to a mobile station, such as encode processing and modulation processing, and outputs the processed signal to the antennas 57.

The wireless reception processor 55 performs predetermined signal processing on a wireless signal sent from a mobile station, such as demodulation processing and decode processing. The wireless interface 56 converts wireless signals send or received by the antennas 57 into signals to be processed by the radio base station apparatus 50, or vise versa, by performing frequency conversion processing, such as an upconvert or downconvert.

The wireless reception processor 55 and the wireless interface 56 define the radio receivers 1 and 1′, 1A, and 1B according to the above-described embodiment and the variations.

For example, the wireless reception processor 55 may be embodied with the signal division circuit(s) 3 or 30A-30C, the AD converters 4 and 5, or 4A, 5A, 4B, and 5B, the digital reception unit 6, the demodulator 7, the memory 8, the pilot signal generator 9, the level variable circuit 10, and the pilot signal application unit 11 in the radio receivers 1 and 1′, 1A, and 1B, according to the above-described embodiment and the variations. The wireless interface 56 may be embodied with the analog reception unit 2 in the radio receivers 1 and 1′, 1A, or 1B according to the above-described embodiment and the variations.

The antennas 57 each function as a transmission antenna that sends a wireless signal to a base station and/or a reception antenna that receives a wireless signal send from a mobile station. It is noted that some of the antennas 57-1 to 57-K may function as transmission antennas and the rest may function as reception antennas. Alternatively, each of the antennas 57-1 to 57-K may function as both transmission and reception antennas.

The CPU 58 controls the wired reception processor 52, the wired transmission processor 53, the wireless transmission processor 54, and the wireless reception processor 55, in cooperation with the logic circuit 59 and the memory 60 that are connected to the CPU 58 via a bus.

As described above, the radio receivers 1, 1′, 1A, and 1B in accordance with the above-described embodiment and the variations, may be applicable to the radio base station apparatus 50.

Although the pilot signal generator 9 is configured as a frequency divider which divides the clock signal by four in the above-described embodiment and the variations, the frequency of the pilot signal may be set to any suitable value, as long as the pilot signal does not interfere with an IF signal.

Further, the variation has been described in the context of a dual-stage connection wherein signal division circuits 30B and 30C are connected subsequent to a signal division circuit 30A and four AD converters are used. However, reception processing may be performed using more than four AD converters, by employing signal division circuits in a multiple-stage connection configured in the similar manner.

For example, by connecting signal division circuits in N- (N is a natural number of two or more) stage connection, reception processing may be performed using 2^{N} AD converters, thereby achieving a reception circuit 1′ having a resolution 2^{N} times greater than the resolution of each AD converter.

The AD converters having the same resolution are used in the above-described embodiment and the variations, and this can reduce the procurement cost of the components and simplify the component management. Alternatively, the AD converters may have different resolutions.

In accordance with the disclosed technique, the reception dynamic range of the radio receiver can be enhanced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A radio receiver comprising:
a signal divider that divides an intermediate frequency signal obtained by converting a frequency of a radio frequency signal received at an analog reception circuit, into a plurality of signal fragments based on an amplitude, and outputs the signal segments; and
a plurality of analog to digital converters that perform an analog to digital conversion on the respective signal fragments divided by the signal divider, and output the signal fragments toward a digital reception circuit.

2. The radio receiver according to claim 1, wherein the signal divider comprises at least one signal division circuit comprising an input section that receives the intermediate frequency signal and two output sections that divide the intermediate frequency signal received through the input section into two signal fragments based on the amplitude, and output the signal fragments.

3. The radio receiver according to claim 2, wherein the signal divider comprises a plurality of signal division circuits, and the plurality of signal division circuits have a signal division circuit unit configuration wherein the respective input sections of a pair of signal division circuits are connected to two output sections of a signal division circuit on a signal upstream side.

4. The radio receiver according to claim 1, wherein the signal divider has a circuit that generates a signal discontinuity in a signal division boundary, and the radio receiver further comprises a signal discontinuity removal unit that eliminates an effect of the signal discontinuity generated in the signal divider.

5. The radio receiver according to claim 2, wherein the signal division circuit has a circuit that outputs output signals from a pair of push-pull connected transistors, the output signals containing a signal discontinuity in a signal division boundary, the radio receiver further comprises a signal discontinuity removal circuit that eliminates an effect of the signal discontinuity by adjusting a signal clip position in each of the transistors in the signal division circuit.

6. The radio receiver according to claim 1, further comprising
a storage that stores reference value information;
a pilot signal generator that generates a pilot signal having a frequency different from a frequency of the intermediate frequency signal; and
a corrector that compares the reference value information and the pilot signal, and corrects a time-induced deviation in a signal division boundary in the signal divider.

7. A method of calibrating a radio receiver comprising a signal divider that divides an intermediate frequency signal obtained by converting a frequency of a radio frequency signal received at an analog reception circuit, into a plurality of signal fragments based on an amplitude, and outputs the signal segments; and a plurality of analog to digital converters that perform an analog to digital conversion on the respective signal fragments divided by the signal divider, and output the signal fragments toward a digital reception circuit, the method comprising:
inputting a calibration signal from an input side of the signal divider;
comparing the calibration signal against a reference signal, and adjusting the calibration signal such that the calibration signal matches the reference signal; and
determining a signal level of a pilot signal having a frequency different from a frequency of the intermediate frequency signal such that the pilot signal matches the adjusted calibration signal.

8. The method to calibrate a radio receiver according to claim 7, wherein the calibration signal is a sinusoidal wave signal having a same frequency as a frequency of the intermediate frequency signal.

9. A method of correcting a time-induced deviation in a radio receiver comprising a signal divider that divides an intermediate frequency signal obtained by converting a frequency of a radio frequency signal received at an analog reception circuit, into a plurality of signal fragments based on an amplitude, and outputs the signal segments; and a plurality of analog to digital converters that perform an analog to digital conversion on the respective signal fragments divided by the signal divider, and output the signal fragments toward a digital reception circuit, the method comprising:
inputting a calibration signal from an input side of the signal divider;
comparing the calibration signal against a reference signal, and adjusting the calibration signal such that the calibration signal matches the reference signal;
determining a signal level of a pilot signal having a frequency different from a frequency of the intermediate frequency signal such that the pilot signal matches the adjusted calibration signal;
storing the signal level of the pilot signal as reference value information; and
comparing an input pilot signal against the reference value information, and correcting the time-induced deviation in the signal division boundary in a signal divider.

10. A radio base station apparatus comprising a radio receiver comprising:
a signal divider that divides an intermediate frequency signal obtained by converting a frequency of a radio frequency signal received at an analog reception circuit, into a plurality of signal fragments based on an amplitude, and outputs the signal segments; and
a plurality of analog to digital converters that perform an analog to digital conversion on the respective signal fragments divided by the signal divider, and output the signal fragments toward a digital reception circuit.
